(19) United States
(12) Patent Application Publication
(10) Pub. No.: US 2011/0201315 A1
(43) Pub. Date: Aug. 18, 2011

(54) PROVIDING WEB-ACTIVATED CALLBACK BY JUST DIALLING AND PRESSING THE CALL BUTTON

(76) Inventors: Amichay Oren, Rosh-A-Ayin (IL); Jasmine Aharon, Tel Aviv (IL); Tzahi Efrati, Giv'ataim (IL)

(21) Appl. No.: 12/682,951

(22) PCT Filed: Oct. 12, 2008
(86) PCT No.: PCT/IL08/01342

§ 371 Date: May 4, 2011

Related U.S. Application Data
(60) Provisional application No. 60/960,821, filed on Oct. 16, 2007.
(60) Provisional application No. 60/960,822, filed on Oct. 16, 2007.

(51) Int. Cl. H04M 3/42

(52) U.S. Cl. 455/414.1

(57) ABSTRACT

The application relates to web-activated callback for wireless phones. Web-activated callback such as JAJAH is known. To originate a call when using conventional web-activated callback, a user must connect to the Internet, activate the web browser, log into his account, request callback while specifying caller and callee phone number, and finally answer the incoming call that was set up by the callback server. However, the combination of steps is considered problematic. Therefore, the major object of the application is to enable user of wireless phones to make use of web-activated callback by just dialling or selecting a callee phone number from a contact list and pressing the “CALL” button to originate a call. The object is achieved in that a software running on the wireless phone hides all the above mentioned steps from the user. Hence, it will be invisible to the user that a callback service is being used in particular because the software receives and answers the incoming call from the callback server.

### FIELD OF THE INVENTION

This invention generally concerns wireless phones and more specifically to usage of internet browsing enabled cellular phones for accessing web-activated telephony providers.

### BACKGROUND OF THE INVENTION

At the background of the invention lie the following two major recent trends: (a) The development of multi-purpose hand-held devices ranging from personal digital assistants PDA's, sophisticated pocket-computers and the like “gadgets” on the one hand, to 3rd generation cell-phones on the other hand; and (b) Web activated telephony Providers such as SKYPE and JAJAH, which offer low-rate communication, mainly based on VoIP.

It is thus only expectable that the above two categories should be integrated, namely to achieve accessibility of the hand-held devices to web activated telephony providers in an effective and friendly manner.

However, the use of web activated telephony is usually a multi-phase, complex and time consuming process, unsuitable for straightforward phone calls, and therefore requests the employment of full-size computers, whether desktop or portable (laptops).

For example, when one wants to use a web activated telephony Service Provider, he/she must first connect to the internet, then activate the web browser or the service provider application, and only then, after logging into his/hers account, communicate via the Service Provider facilities; in case of web activated CALL-BACK based service (such as by JAJAH), a procedure of answering an incoming call from the Service Provider server must be followed.

This combination of steps and functions has been found difficult to be implemented in mobile phones, even with regard to the more sophisticated internet browsing enabled devices. An attempt to surmount such difficulty is described, e.g. in WO2008/070434A1.

It is therefore the major object of the present invention to enable mobile-phones holders to enjoy the services of web activated telephony provider in an easy, straightforward manner, namely, the same way as if “normally” used, that is, just Dialing or selecting a number from a contact list and pressing the “CALL” button to initiate the call.

It is a further object of the invention to achieve the above object in an invisible, seamless way through the implementation of the Service Provider Applications on the wireless Operating System (as will be further described below).

### SUMMARY OF THE INVENTION

According to one, general aspect of the present invention there is provided a method of processing a call originating from a wireless phone, routed through several channels, mediated by a VoIP callback Service Provider, using designated applications installed on the wireless phone, comprising the steps of detecting a call initiation by an Event Listener Object Application; sending an operating command by the Event Listener Object Application to a Decision Making Application; sending by the Decision Making Application information to a Call Trigger Application; sending by the Call Trigger Application a notification to the callback Service Provider server containing caller and the callee identification and call information; applying a callback routine by the Service Provider; simulating to the caller a direct call signal throughout the foregoing steps; and, cease simulation upon completing connection with the callee.

According to some embodiments of the present invention, the Application's simulation is in the form of a virtual ring-tone.

According to some further embodiments of the present invention, the Application's simulation is in the form of a virtual busy-tone in case connection with the callee has failed.

According to some additional embodiments of the present invention, the Event Listener Object Application is triggered upon activation of the wireless phone Operating System.

Furthermore, according to some embodiments of the present invention, the Event Listener Object Application is activated by the caller.

According to yet some further embodiments of the present invention, the Event Listener Object Application is activated by a “CALL” event occurred at the wireless phone.

Additionally, according to some embodiments of the present invention, the method comprises the further step of detecting the wireless phone connection to the Internet by the Call Trigger Application.

According to some additional embodiments of the present invention, the Call Trigger Application is enabled to route the call through the caller direct wireless phone telephony provider.

According to some yet further embodiments of the present invention, the Call Trigger Application will send said notification by an SMS message.

Furthermore, according to some embodiments of the present invention, the designated Application is adapted, upon receiving an incoming callback, to generate a simulated ring-tone.

According to some further embodiments of the present invention, the Call Trigger Application is adapted to send said notification through the Internet network.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the course of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow-chart illustrating a call processed through a wireless phone application and completed through a callback service provider or through a direct telephony. Service Provider according to an embodiment of the invention;

FIG. 2 is a more detailed flow-chart the process of FIG. 1 which includes the Service Provider Application decision making; and,

FIG. 3 is a diagrammatic representation of the process.

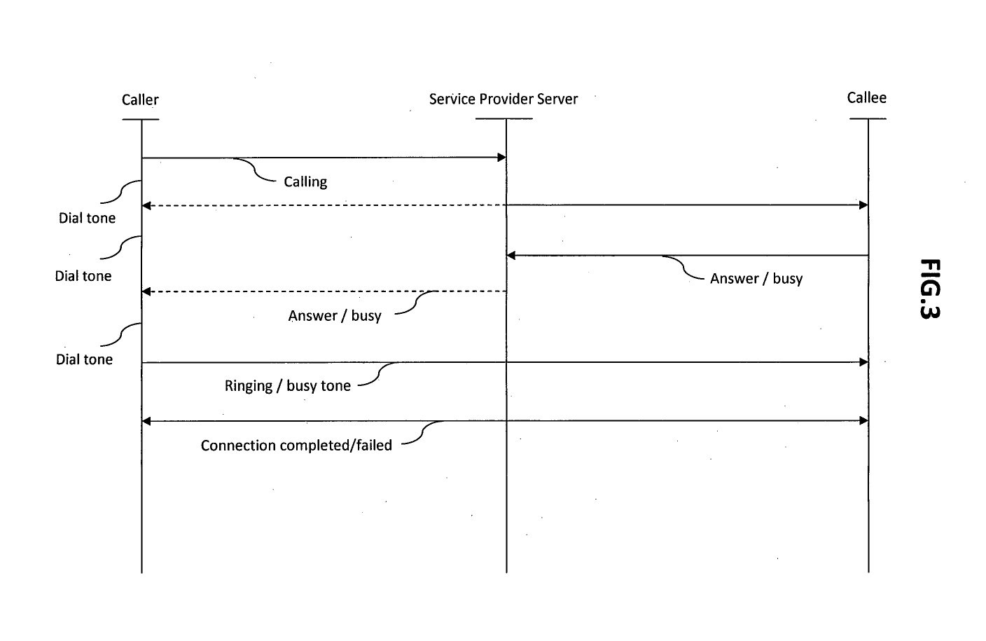

### DETAILED DESCRIPTION OF THE PREFERRED EMBODIMENTS

In order to implement the method of this invention, the user will have to go through a one-time process of familiarizing vis-a-vis the service provider. Hence, a registration or subscription procedure must be conducted in the traditional fashion, using a desktop or portable computer or any other portable device connected via GPRS, WIFI or any other internet mediation infrastructure. Once completed, the user will download his/her personal Operating System tailored Application to the mobile device.

The service provider database being already stored with the identification particulars of this specific subscriber, will process calls placed by him/her the same way as with respect to any other of its subscribers, including, but not limited to the contacts history which is also stored in the memory of the wireless phone.

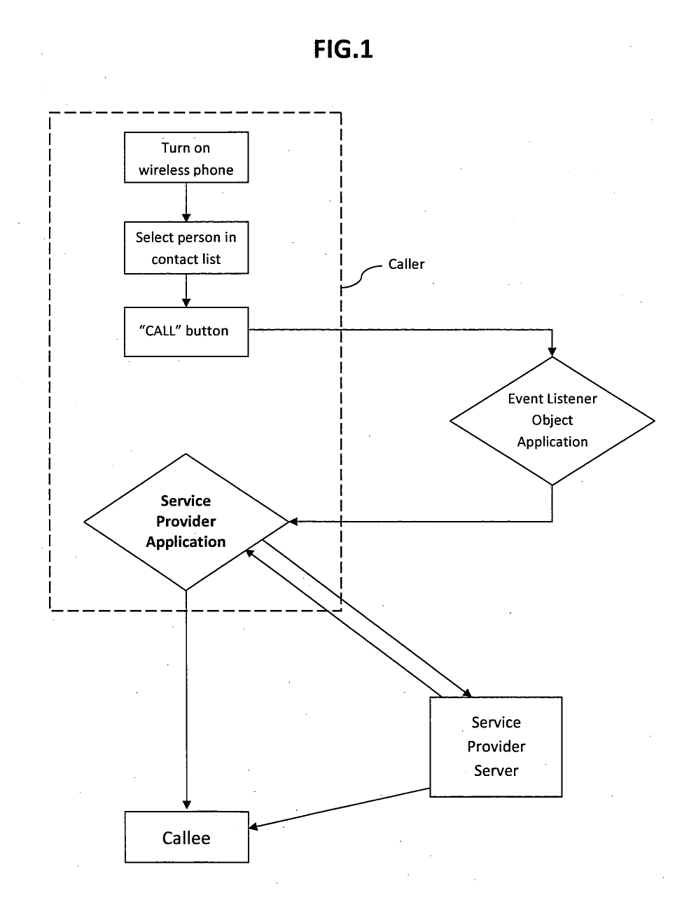

The first stage of the process (see FIG. 1) is conventional: selecting a number from the contact list (or dial a new counterparty number), and pressing “CALL” button.

In one embodiment of the invention, the wireless phone, once switched on, will load and activate the call-back Service Provider Application parallel to the wireless phone Operating System.

This effect can be attained for certain wireless phone Operating System such as Symbian or JavaPhone. These Operating Systems enable immediate integration of and full functionality with third party installed applications (such as JAJAH).

In another embodiment of the Invention, relevant to cases wherein the wireless phone Operating System does not enable third party Applications to become loaded and interlaced with the device Operating System upon start, or does not allow the Application to monitor user activities (i.e. events), the user will still be able to operate the application on the Operating System foreground by intentionally activating the application from the application menu.

Once operated, the Service Provider Application will start an Event Listener Object Application in the background of the wireless phone Operating System.

The Event Listener Object is a way for the Application to trace an activity (i.e. event) generated by the user, and react in response. The Event Listener Object operates in the background, constantly monitoring relevant user activities. According to a preferred of the present Invention, the Event Listener Object will listen and trace a call initiation by the user, i.e. pressing the wireless phone “CALL” button.

Once the caller initiates a call by pressing the “CALL” button, the Event Object Listener will trace the event and trigger a Decision Making Application.

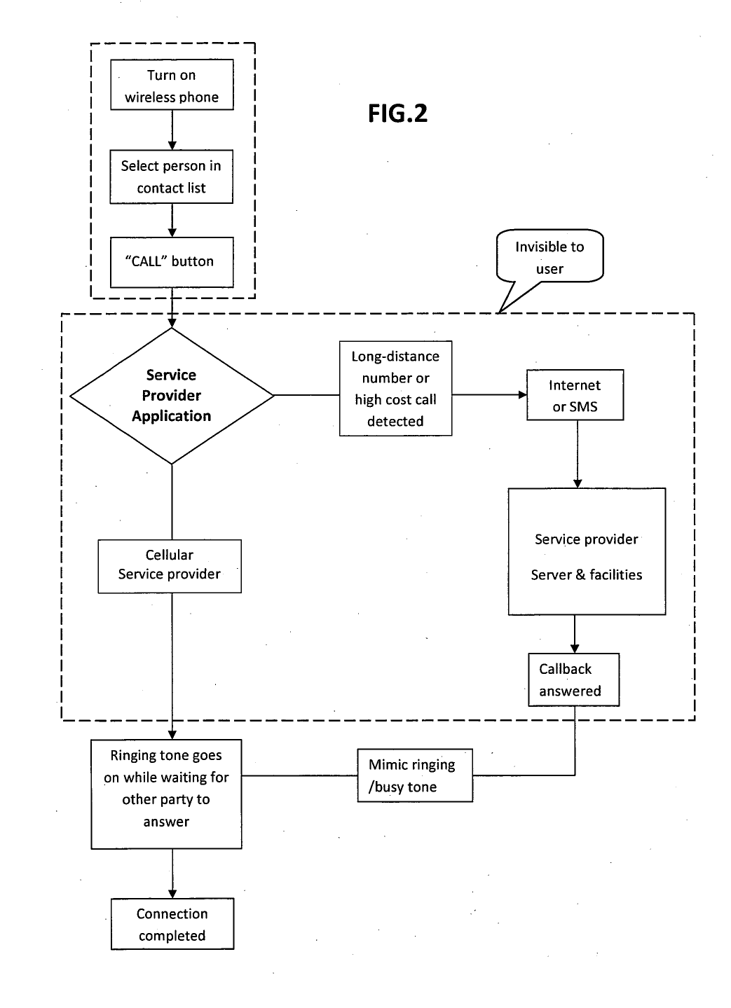

The Decision Making Application will trace the call Identification (e.g. destination), sent to it by the Event Listener Object and may “choose” one of the following options (see FIG. 2):
(a) To route the call through the VoIP, call-back Service Provider facilities;
(b) To route the call through the available wireless phone cellular Service Provider or any other Service Provider; or
(c) Any combination of options (a) and/or (b).

These options lend themselves to certain variations, for example depending on whether the callee is one of the subscriber contact member of the callback Service Provider, whether the placed call is transatlantic or local, and so forth. These variables may be changed subject to the callback Service Provider decisions or user predefined configurations.

Assuming that the Service Provider Decision Making Application decided that the call will be routed through its facilities, it will operate a Call Trigger Application that will act in one of two manners:
(a) If the wireless phone is connected to the Internet, the application will send information (either in packets, multiplexing or in any other form) over the Internet to the Service Provider server containing the caller ID number, and the callee phone number.
(b) If the wireless phone is not connected to the Internet, the application will send an SMS message to the Service Provider server (using the user direct telephony Service Provider).

These and other parameters might vary subject to the Service Provider facilities, or to the wireless phone application settings, specified by the user, prior to the call itself, such as to configure which prefix to include in the callback triggering, and which prefix should be processed normally without intervention. For example, the user may choose never to enable the SMS massage functionality.

Once the Service Provider server received the message (either from the Internet or in any other way), a callback process is triggered, and the server will now call both the caller and the callee by using the callback method and channeling the call through its facilities.

Since the call back Service Provider calls both the caller and the callee, no use of any other Provider is made by user, thus no further costs are applicable beside those of the call back Service Provider.

Due to its special capabilities as above explained, the application is adapted to detect the optimal method of routing calls, relying on a preconfigured database, thus further cutting-down call rates.

In order to perfect the “transparency” (invisibility) of the processing in as much as the caller in concerned, the Application will mimic or simulate a “Ringing-tone” until the connection is completed, or a “Busy-tone” in case connection has failed.

This application will be responsive for receiving the incoming call from the callback server and checking its status, while constantly creating a virtual ringing tone as if a regular call is being in process.

Hence, no trace of an incoming call from the callback Service Provider will be noticed by the caller (acoustic or seen on the device screen), the application will receive and answer the call and the user will only hear a ring tone until connection in completed, similar to normal calls.

Further processing the call, billing the subscriber, etc., will follow the same way as with respect to other, non-cell phone originated calls.

While the invention has been described in terms of various preferred embodiments, the skilled artisan will appreciate that various modifications, substitutes, omissions, and changes may be applied without departing from the spirit thereof. Accordingly, it is intended that the scope of the present invention be limited solely by the construction of the appended claims, including equivalents thereof.

1. A method of processing a call originating from a wireless phone, routed through several channels, mediated by a VoIP callback Service Provider, using designated applications installed on the wireless phone, comprising the steps of:
(a) Detecting a call initiation by an Event Listener Object Application;
(b) sending an operating command by the Event Listener Object Application to a Decision Making Application;
(c) sending by the Decision Making Application information to a Call Trigger Application;
(d) sending by the Call Trigger Application a notification to the callback Service Provider server containing caller and callee identification and call information;
(e) applying a callback routine by the Service Provider;
(f) simulating to the caller a direct call signal throughout the foregoing steps and,
(g) cease simulation upon completing connection with the callee.

2. The method as claimed in claim 1, wherein the said simulation is in the form of a virtual ring-tone.

3. The method as claimed in claim 1, wherein the said simulation is in the form of a virtual busy-tone in case connection with the callee has failed.

4. The method as claimed in claim 1, wherein the Event Listener Object Application is triggered upon activation of the wireless phone Operating System.

5. The method as claimed in claim 1, wherein the Event Listener Object Application is activated by the caller.

6. The method as claimed in claim 1, wherein the Event Listener Object Application is activated by a “CALL” event occurred at the wireless phone.

7. The method as claimed in claim 1 comprising the further step of detecting the wireless phone connection to the Internet by the Call Trigger Application.

8. The method as claimed in claim 7, wherein the Call Trigger Application is enabled to route the call through the caller direct wireless phone telephony provider.

9. The method as claimed in claim 8, wherein the Call Trigger Application is adapted to send said notification by an SMS message.

10. The method as claimed in claim 1, wherein the designated Application is adapted, upon receiving an incoming callback, to generate a simulated ring-tone.

11. The method as claimed in claim 1, wherein the Call Trigger Application is adapted to send said notification through the Internet network.

12. A communication system for processing a call originating from a wireless phone, routed through several channels, mediated by a VoIP Service Provider, using designated applications installed on the wireless phone and a callback routine, the system comprising:
(a) at least one wireless phone communication system;
(b) at least one VoIP Service Provider;
(c) means for communication between the at least one VoIP Service Provider and the at least one wireless phone communication system;
(d) a tracking means for tracking a call initiation by an Event Listener Object Application;
(e) at least one computer processor adapted to send:
i) an operating command by the Event Listener Object Application to a Decision Making Application;
ii) bits of information from the Decision Making Application to a Call Trigger Application; and,
(f) means for providing a notification from the Call Trigger Application to the callback Service Provider server containing caller and callee identification and call information.

13. A computer software product for processing a call originating from a wireless phone, routed through several channels, mediated by a VoIP Service Provider, using designated applications installed on the wireless phone and a callback routine, comprising a computer-readable medium in which program instructions are stored, which instructions, when read by a computer, cause the computer to:
(a) track a call initiation by an Event Listener Object Application;
(b) send an operating command by the Event Listener Object Application to a Decision Making Application;
(c) send by the Decision Making Application bits of information to a Call Trigger Application;
(d) send by the Call Trigger Application a notification to the callback Service Provider server containing caller and callee identification and call information;
(e) apply a callback routine by the Service Provider;
(f) simulate to the caller, with the Application, throughout the foregoing steps, a direct call signal; and,
(g) cease simulation upon completing connection with the callee.
